(19) United States
(12) Patent Application Publication
(10) Pub. No.: US 2012/0237655 A1
(43) Pub. Date: Sep. 20, 2012

(54) BAKING MOLD

(75) Inventor: Valentin Engler, Zurich (CH)

(73) Assignee: BETTY BOSSI AG, Zurich (CH)

(21) Appl. No.: 13/421,066

(22) Filed: Mar. 15, 2012

(30) Foreign Application Priority Data
Mar. 17, 2011 (CH) 00451/11

(51) Int. Cl. A47J 43/20; A21D 6/00

(52) U.S. Cl. 426/504; 249/164

(57) ABSTRACT

A baking mold (1) having a first mold (3) and a second mold (5) which are connected to each other by a clamping ring (7, 9).

### CROSS-REFERENCE TO RELATED APPLICATIONS

This application claims the benefit of Swiss Patent Application 00451/11, filed Mar. 17, 2011, which is incorporated herein by reference as if fully set forth.

### BACKGROUND

The subject matter of the invention is a baking mold.

Baking molds are known in a multiplicity of embodiments and are used both domestically and in commercial operations.

A baking mold customarily comprises a shell-shaped lower part which can receive the liquid, pasty or otherwise deformable dough prepared in a mixing bowl and can keep the dough in shape during the baking and can act in a shaping manner. Baking molds have a volume for receiving the dough at least during the liquid or viscous form thereof, but do not prevent said dough from “rising”.

During conventional baking, in particular in accordance with particular recipes, i.e. without finished products, the dough is produced independently of the baking mold and in separate vessels and frequently also by dough-mixing machines or other dough-mixing appliances.

### SUMMARY

It is an object of the present invention to provide a baking mold in which the dough can be produced within the baking mold.

It is a further object of the invention to configure the baking mold in such a manner that differently shaped cakes can be baked therein.

### BRIEF DESCRIPTION FO THE DRAWINGS

The invention is explained in more detail with reference to an illustrated exemplary embodiment. In the drawings

FIG. 1 shows a perspective illustration of the baking mold with a shell and a cover,

FIG. 2 shows a side view of the baking mold in FIG. 1,

FIG. 3 shows a side view of the shell of the baking mold,

FIG. 4 shows a top view of the uncovered shell according to FIG. 3,

FIG. 5 shows an exploded drawing of the shell with a lower retaining ring and a connecting ring,

FIG. 6 shows a side view of the shell with the lower retaining ring, with the retaining ring snapped onto the shell,

FIG. 7 shows a top view of the connecting ring,

FIG. 8 shows a side view of the connecting ring,

FIG. 9 shows a side view of the lower retaining ring,

FIG. 10 shows a top view of the retaining ring, and

FIG. 11 shows a section through the connecting ring along line XI-XI in FIG. 10.

### DETAILED DESCRIPTION OF THE PREFERRED EMBODIMENTS

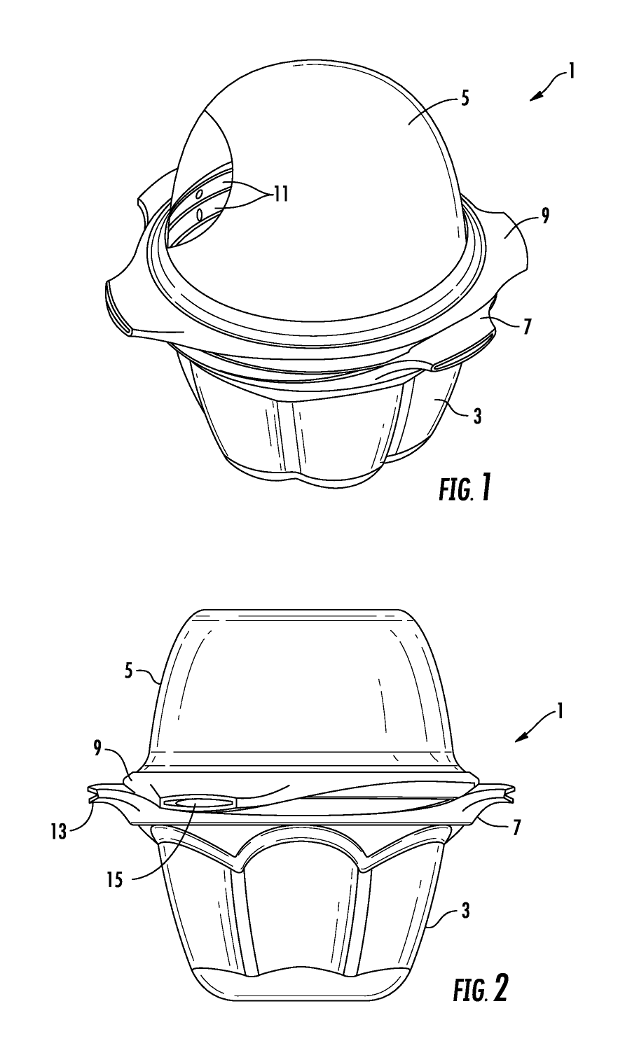

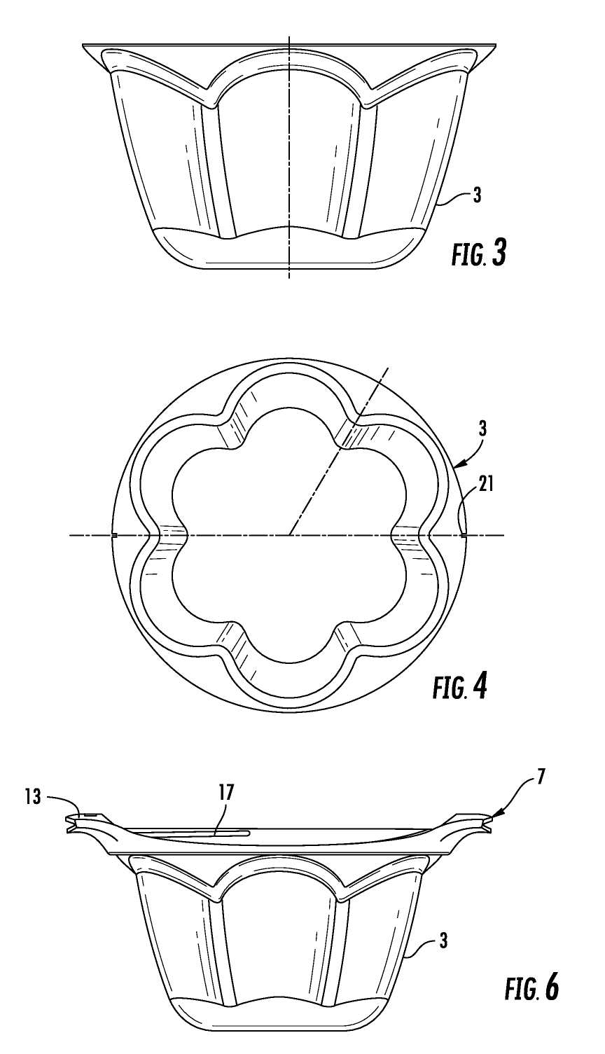

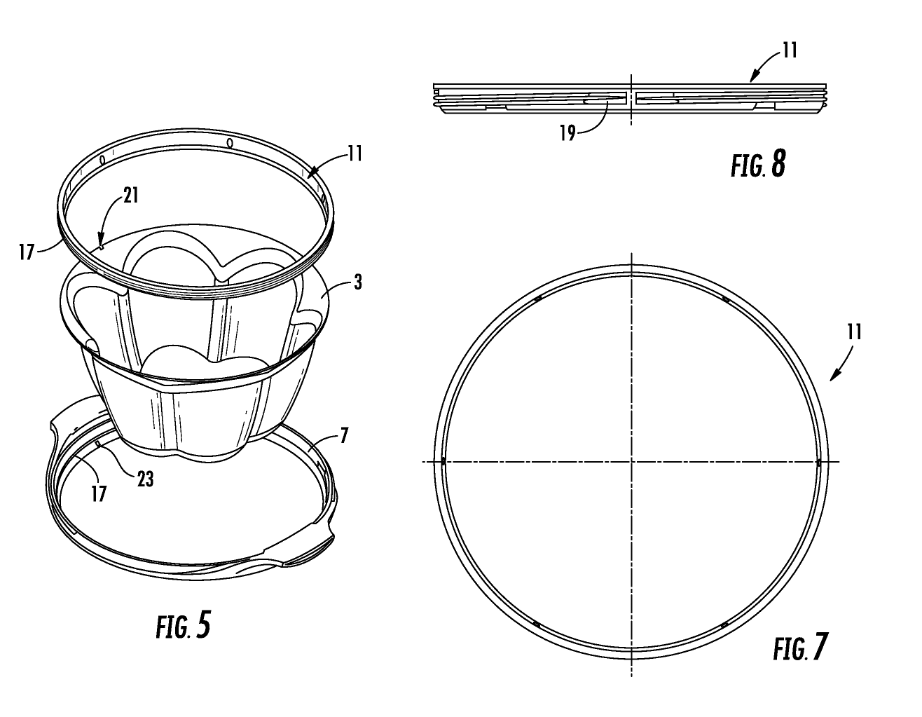

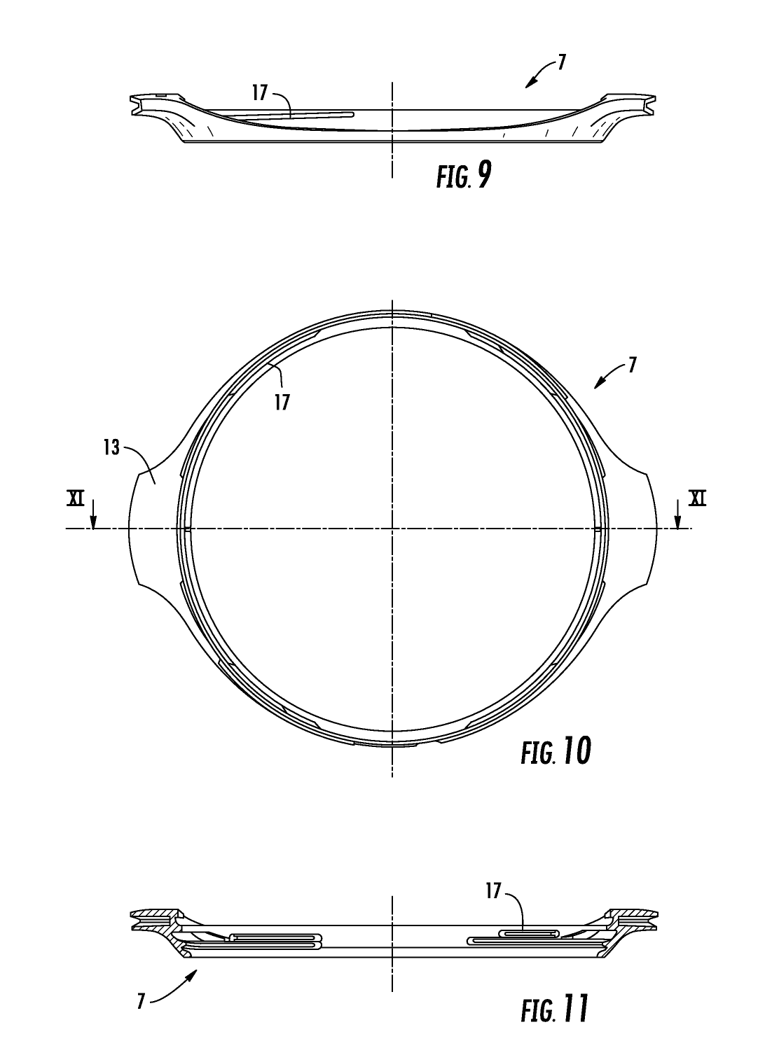

In FIGS. 1 and 2, reference sign 1 denotes a baking mold according to the invention, comprising a first mold 3 and a second mold 5, a lower retaining or outer ring 7, which is pushed from below over the first mold 3, and an upper retaining or outer ring 9, said retaining or outer rings preferably being of identical design. An inner ring 11, with which an outer ring 7 is in each case connected to the first mold 3, can be seen in FIG. 1 merely by way of indication. The lower retaining ring 7 and the upper retaining ring 9 have mutually opposite holding handles 13, 15. These serve to rotate the retaining rings 7, 9 in relation to each other in order to close the two molds 3, 5, and in order to hold the baking mold 1 during shaking and to carry said baking mold. For this purpose, the two retaining rings 7, 9 have threads or threaded sections 17 in the interior. These threaded sections 17 enter into engagement with corresponding threads or threaded sections 19 on the periphery of the inner ring 11.

In order to prevent rotation of the lower retaining ring 9 on the edge of the shell 3, incisions 21, in which cams 23 provided on the lower retaining ring 17 engage, are formed on the upper edge of the mold 3.

The joining together of the first mold 3 and of the second mold 5 with the clamping arrangement, consisting of the two retaining rings 7, 9 and the inner ring 11, is described briefly below. The lower outer ring or retaining ring 7 is pulled upward from below over the first mold 3 as far as the upper edge thereof and is fixed there until the cams 23 snap into the incisions 21 on the shell. The inner ring 11 is then placed on and connected to the retaining ring 7 by rotation. After all of the ingredients of the cake or for the dough have been placed into the first mold 3 or the second mold 5, the other mold 3, 5 is laid onto the first mold 3 and connected by the upper retaining ring 9, via a rotational movement of the latter, to the lower retaining ring by the threaded or bayonet fastening. The baking mold 1 is now completely closed.

The components placed into one of the molds, for example melted butter, eggs, fat component etc. and flour, sugar and ground nuts can now be connected to one another and mixed by shaking to form a dough. The finished dough can then either be baked in the first mold 3 or in the second mold 5 after the two molds 3, 5, which have been joined together for the shaking and mixing of the dough ingredients, have been separated.

In order to prevent the finished dough from sticking in one of the molds 3, 5, the inner surface thereof is provided with a coating to which the dough does not stick, and therefore, upon separation of the two shells 3, 5, the dough remains only in the lower shell in each case and can be thoroughly baked therein.

### REFERENCE NUMBER KEY

1 baking mold

3 first mold

5 second mold

7 lower retaining ring

9 upper retaining ring

11 inner ring

13 holding element

15 holding element

17 threaded sections

19 threaded sections

21 incisions

23 cam

1. A baking mold (1), comprising a first mold (3) with a standing surface, a circumferential surface and an encircling edge, a second mold (5) is adapted to be placed onto the first mold (3) so that the first and second molds are connectable, and a clamping ring arrangement that connects the first and second molds together.

2. The baking mold according to claim 1, wherein the clamping ring arrangement comprises two outer or retaining rings (7, 9) which can be respectively pushed over circumferential surfaces of the first mold (3) and the second mold (5), and at least one inner or connecting ring (11) which can be placed between the first mold (3) and the second mold (5).

3. The baking mold according to claim 2, wherein the outer rings (7, 9) engage under edges of the first mold (3) and of the second mold (5) and are connectable to the at least one inner ring (11) by mutual rotation.

4. The baking mold according to claim 2, wherein the outer rings (7, 9) and the at least one inner ring (11) are connectable by threads or threaded sections (17, 19) provided thereon or by bayonet-type connecting elements.

5. The baking mold according to claim 2, wherein mutually opposite holding handles (13, 15) are integrally formed on the outer rings (7, 9).

6. The baking mold according to claim 1, wherein the first mold (3) and the second mold (5) have an identical shape.

7. The baking mold according to claim 1, wherein the first mold (3) and the second mold (5) have a different three-dimensional shape.

8. The baking mold according to claim 2, wherein the outer rings (7, 9) have an identical shape.

9. The baking mold according to claim 2, wherein the outer rings (7, 9) have a different shape from one another.

10. The baking mold according to claims 1, wherein one or two of the inner rings (11) are used for the connection of the two shells (3, 5).

11. A method of using a baking mold, comprising providing a baking mold (1) including a first mold (3) with a standing surface, a circumferential surface and an encircling edge, a second mold (5) is adapted to be placed onto the first mold (3) so that the first and second molds are connectable, and a clamping ring arrangement that connects the first and second molds together,
placing dough ingredients in the first mold,
connecting the first mold to the second mold with the clamping ring,
shaking the dough ingredients to form a dough ready for baking, and
baking the dough in one of the two molds (3, 5).
